(19) United States
(12) Patent Application Publication
(10) Pub. No.: US 2012/0092161 A1
(43) Pub. Date: Apr. 19, 2012

(54) SYSTEMS AND METHODS FOR NOTIFYING PROXIMAL COMMUNITY MEMBERS OF AN EMERGENCY OR EVENT

(75) Inventor: Rodger M. West, Marietta, GA (US)

(73) Assignee: SMARTWATCH, INC., Atlanta, GA (US)

(21) Appl. No.: 13/275,660

(22) Filed: Oct. 18, 2011

Related U.S. Application Data
(60) Provisional application No. 61/394,009, filed on Oct. 18, 2010.

(51) Int. Cl. G08B 21/00

(52) U.S. Cl. 340/540

(57) ABSTRACT

Aspects of the present disclosure generally relate to systems and methods for an automated community notification system (“CNS”) that is configured to notify certain individuals with relevant information relating to occurrence of an event or emergency at a given geographical location. Generally, aspects of the system include operative connections to one or more security system providers (“SSPs”) to identify events/emergencies at properties. In alternate embodiments, system users provide event information to the CNS via users' electronic devices. According to one aspect, system users register with the CNS and provide user information, preferences, geographic information, etc., and the CNS subsequently utilizes that information (in connection with other third party information sources) to establish “neighborhood networks” for system users. Typically, members of in the same neighborhood network are notified and provided with relevant information when an emergency occurs at the property or geographic location of another user in the members' network.

### CROSS REFERENCE TO RELATED APPLICATION

This application claims benefit under 35 U.S.C. §119(e) of U.S. Provisional Patent Application No. 61/394,009, filed Oct. 18, 2010, and entitled “Systems and Methods For Notifying Proximal Community Members of an Emergency Event”, which is incorporated herein by reference as if set forth herein in its entirety.

### TECHNICAL FIELD

The present systems and methods relate generally to an automated notification system for notifying system users of an emergency, event, or occurrence at a given location, and more particularly to systems and methods for automatically notifying and providing relevant information to registered system users, such as those within a specific geographic area or interrelated as part of a community, about an occurrence at a given physical location.

### BACKGROUND

Many homeowners, renters, business owners, property managers, and others utilize property security systems in connection with their properties. Generally, such property security systems include an operative connection via a “security system” to a third party security system provider (“SSP”) that is automatically contacted in the event of an emergency at a property, and the SSP then dispatches police, firefighters, EMS units, and other emergency responders to the property as needed. The security systems often incorporate video cameras, motion sensors, door and window entry detectors, audio communication capabilities, and other similar technologies that enable a SSP to assess a situation at a property, communicate directly with the property owner (if possible), and make a determination regarding an appropriate action to take. Such security systems also typically utilize a control unit at the property that allows the property owner to activate and deactivate the security system, communicate remotely with a SSP representative (during an emergency or otherwise), create a security system password, and perform other similar functions.

Traditional security systems, however, have several disadvantages. For example, when a security system is triggered, it can take emergency responders an extended period of time to arrive at the property to assist with the emergency. In a home intruder setting, a delay of even five or ten minutes could drastically affect the property owner's safety and/or whether the intruder is able to carry out certain activities (e.g., theft, vandalism, etc.). Additionally, even when emergency responders arrive at the property, details associated with the intrusion, emergency, or other situation can be difficult to ascertain, either because the property owner was shaken during the emergency (and cannot recall details), or because the property owner was not at the property during the emergency, or for other similar reasons. This lack of information can hinder efforts to catch the intruder or take other subsequent action with respect to the emergency.

Further, even those property owners that do not utilize security systems may desire to receive assistance in the event of an emergency, or to participate in an effective “neighborhood watch” type of activity. Those users may not want the cost or enhanced security associated with a fully-enabled home security system, but may desire to have some moderate assistance or knowledge about an emergency occurring at their homes or neighbors' homes. Similarly, users of security systems may not always activate their systems, and thus can be caught off guard during an emergency, home invasion, or the like when their security systems are turned off. Accordingly, those users may desire a way to activate their systems remotely (e.g., from a bedroom during a home invasion), or notify members of their community of an emergency regardless of their use or non-use of a conventional security system.

Additionally, during an emergency or event at a particular physical location, neighbors or other community members or property owners that own properties in geographical proximity to the affected location may desire to be notified regarding the emergency so as to help with the emergency, or protect their own property, or take other action with respect to the emergency. Particularly, a property owner that is not physically at his or her property may desire to be notified when an emergency occurs at a neighboring property so as to take appropriate action with respect to his or her own property (e.g., go to the property to ensure it is safe, remove items from the property that could be in danger of theft, destruction by fire, etc.). Currently, there is no way that neighboring community members of an affected property can be notified in virtually real time of an occurrence or emergency at a neighboring property and be provided with information relating to the occurrence or event.

Therefore, there is a long-felt but unresolved need for a system or method that automatically notifies property owners of an emergency or event at a separate property that is proximally related to a property owner's property. There is an additional need for a system or method that enables remote activation by a particular property owner of a notification system (either separate from or connected to a conventional security system) that notifies and provides relevant information to predefined property owners within the particular property owner's network. Even further, there is a need for a system that enables users to notify other system members of events, occurrences, emergencies, and other relevant happenings via the users' mobile devices. Moreover, there is yet a further need for an electronic, online, easy-to-use community notification system that identifies events (including emergencies), and further disseminates event-related information to predetermined users, so as to enhance the overall safety and deter crime within a community. An ideal system should be easily customizable by users, according to their personal preferences, provide quick and up-to-date information and can be accessed and operated easily by users having minimal technical skills.

### BRIEF SUMMARY OF THE DISCLOSURE

Briefly described, and according to one embodiment, aspects of the present disclosure generally relate to systems and methods for an automated community notification system (“CNS”) that is configured to notify certain individuals of an occurrence or emergency at a given physical location and provides those individuals with relevant information regarding the occurrence or emergency. Generally, aspects of the system include operative connections to one or more security system providers (“SSPs”) to assist with identification of emergencies at properties and provide relevant information to and from the CNS and to other third parties, such as emergency responders. According to one aspect, system users are able to register with the CNS and provide user information, preferences, geographic information, etc., and the CNS subsequently utilizes that information (in connection with other third party information sources) to establish “neighborhood networks” or “communities” for system users. Typically, members of a neighborhood network are notified and provided with relevant information when an emergency occurs at the property or geographic location of another user in the members' network. Generally, neighborhood networks are not limited to adjacently-located physical neighborhoods, but rather can involve persons residing in other geographical areas.

According to another aspect, system users who are members of one or more neighborhood networks are able to transmit information relating to an event or emergency at the respective user's geographic location to the CNS. Subsequently, other users who are members in the same neighborhood network as the reporting user will be notified of such reports via the CNS. According to other aspects of the present disclosure, the present system involves features of web-based as well as mobile device-based application software for the management and utilization of an automated community notification system. Further, in yet other aspects, the present community notification system integrates automated notifications to system users in conjunction with a real-time geo-location corresponding to an event or emergency. Generally, a real-time geo-location corresponding to an event or emergency is obtained with the help of a location sensor embedded in a user's mobile device, and automatically communicated over an electronic network to the CNS. According to yet another aspect, system users are able to access the CNS via the Internet (world wide web) or other network, and manage their accounts, manage their history of alerts, configure various preferences of receiving notifications, and perform other tasks with the help of a simple, user friendly interface.

These and several other aspects, features, and benefits of the claimed invention(s) will become apparent from the following detailed written description of the preferred embodiments and aspects taken in conjunction with the following drawings, although variations and modifications thereto may be effected without departing from the spirit and scope of the novel concepts of the disclosure.

### BRIEF DESCRIPTION OF THE DRAWINGS

The accompanying drawings illustrate one or more embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1 illustrates an exemplary system environment in which an embodiment of the present community notification system is utilized.

FIG. 2 illustrates an exemplary system architecture of the community notification system (“CNS”) according to one embodiment of the present system.

FIG. 3 illustrates an exemplary notification system database schema for storing data and information that is used by an embodiment of the CNS.

FIG. 4 illustrates an exemplary process for generating a network of associated system users and associating those users in a database.

FIG. 5 illustrates an exemplary notification process for notifying and providing relevant event information to neighbors of a system user based on the occurrence of an event or emergency at the user's geographic location.

FIG. 6 shows an exemplary screen shot of a contact person or neighbor's email inbox with an alert/notification message received from an embodiment of the CNS.

FIG. 7 shows an exemplary screen shot of a contact person's or neighbor's mobile device with an alert/notification message received from an embodiment of the CNS and displayed on the mobile device via a SMS message or Internet email display.

FIG. 8 illustrates an exemplary management screen that enables a system user to manage his or her account with an embodiment of the CNS.

FIG. 9 shows an exemplary screenshot of a CNS interface displaying a geo-located event reported by a system user in real time, as seen by other members in the same neighborhood network as the system user.

FIG. 10 shows an exemplary screenshot of an interface for a system user to create a neighborhood network within an embodiment of the CNS.

FIG. 11 shows an exemplary screenshot of a mobile device interface for a system user to join a pre-created neighborhood network within the CNS.

FIG. 12 illustrates an exemplary mobile device process for communicating relevant event information to the CNS, based on the occurrence of an event or emergency at the system user's geographic location.

FIG. 13 (consisting of FIG. 13A and FIG. 13B) shows an exemplary screenshot of a mobile device interface for a system user to create and upload a report to the CNS, based on the occurrence of an event or emergency.

FIG. 14 (consisting of FIG. 14A and FIG. 14B) shows an exemplary screenshot of a mobile device interface for a system user to submit relevant event information to the CNS, as well as to call emergency responders, based on the occurrence of an event or emergency.

### DETAILED DESCRIPTION

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates.

Aspects of the present disclosure generally relate to systems and methods for an automated community notification system (“CNS”) that is configured to notify certain individuals of an occurrence or emergency at a given physical location and provides those individuals with relevant information regarding the occurrence or emergency. Generally, aspects of the system include operative connections to one or more security system providers (“SSPs”) to assist with identification of emergencies at properties and provide relevant information to and from the CNS and to other third parties, such as emergency responders. According to one aspect, system users are able to register with the CNS and provide user information, preferences, geographic information, etc., and the CNS subsequently utilizes that information (in connection with other third party information sources) to establish “neighborhood networks” for system users. Typically, members of a neighborhood network are notified and provided with relevant information when an emergency occurs at the property or geographic location of another user in the members' network.

According to another aspect, system users who are members of one or more neighborhood networks are able to transmit information relating to an event or emergency at the respective user's geographic location to the CNS. Subsequently, other users who are members in the same neighborhood network as the reporting user will be notified of such reports via the CNS. According to other aspects of the present disclosure, the present system involves features of web-based as well as mobile device-based application software for the management and utilization of an automated community notification system. Further, in yet other aspects, the present community notification system integrates automated notifications to system users in conjunction with a real-time geo-location corresponding to an event or emergency. Generally, a real-time geo-location corresponding to an event or emergency is obtained with the help of a location sensor embedded in a user's mobile device, and automatically communicated over an electronic network to the CNS. According to yet another aspect, system users are able to access the CNS via the Internet (world wide web) or other network, and manage their accounts, manage their history of alerts, configure various preferences of receiving notifications, and perform other tasks with the help of a simple, user friendly interface. Various specifics, details, and system embodiments are described in greater detail below.

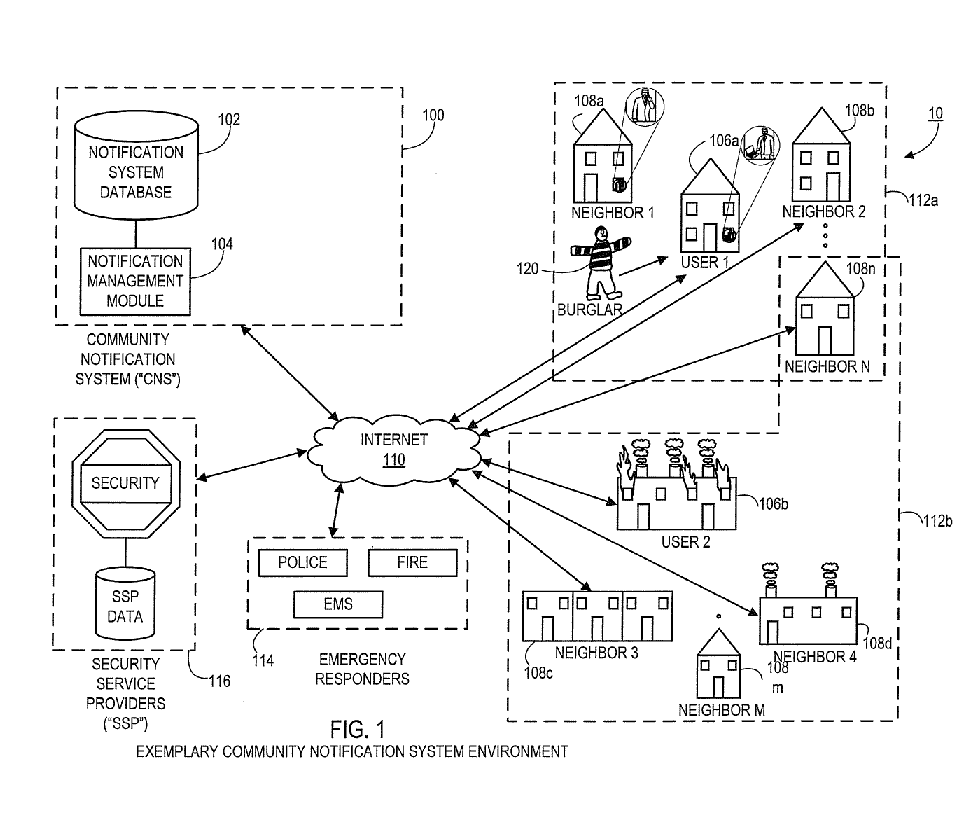

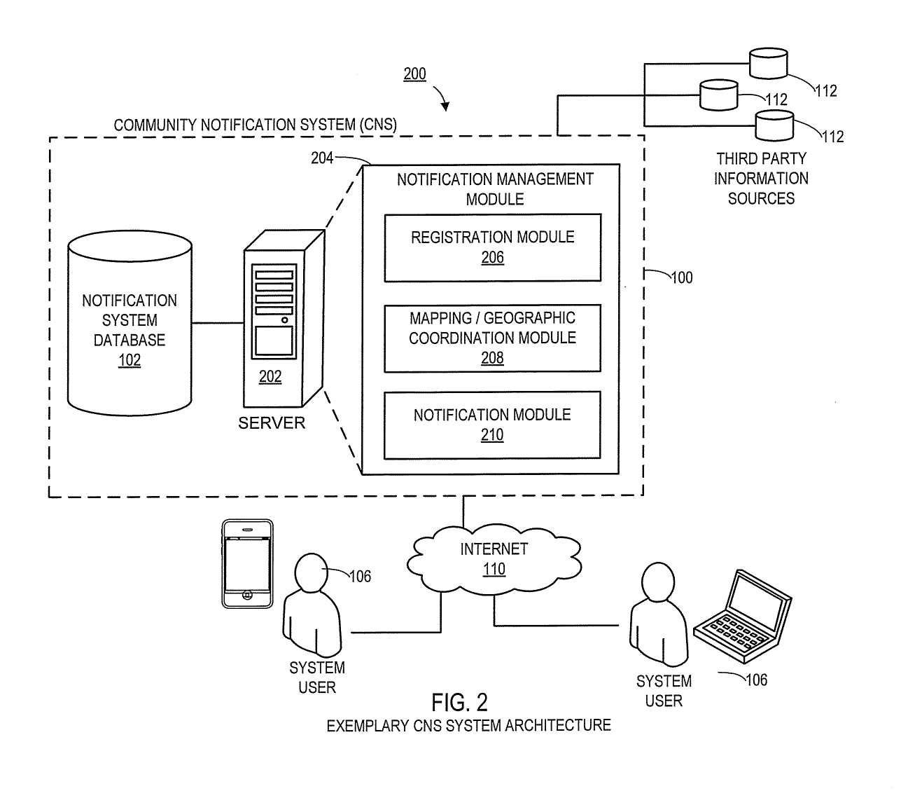

Referring now to the figures, FIG. 1 illustrates an exemplary system environment 10 in which an embodiment of the community notification system (“CNS”) 100 is utilized. As shown, the CNS 100 includes one or more notification system databases 102 for storing relevant user and system information, and a notification management module 104 for carrying out the functions and processes of the CNS. (Architectural details showing various software modules and engines comprising an embodiment of the CNS 100 will be described in greater detail in connection with FIG. 2.) The CNS includes operative (and preferably wireless) connections to various other users, systems, and third parties via a network, such as the Internet 110. Further, as will be understood and appreciated, various networking components like routers, switches, hubs etc., are typically involved in system communications. Although not shown in FIG. 1, it will also be understood that such communications may include one or more secure networks, gateways, firewalls, and the like that provide information security from unwarranted intrusions and cyber attacks.

According to the embodiment shown, the CNS 100 is in operative connection with one or more system users 106 and one or more “neighbors” 108 of the system users (who are themselves preferably system users 106), which form one or more neighborhood networks 112. Embodiments of the CNS are also operatively connected with one or more emergency responders 114, such as police, firefighters, emergency medical services (EMS), and other similar entities, as well as one or more security service providers (“SSPs”) 116 (i.e., providers of conventional security systems to homes, businesses, and other physical property locations).

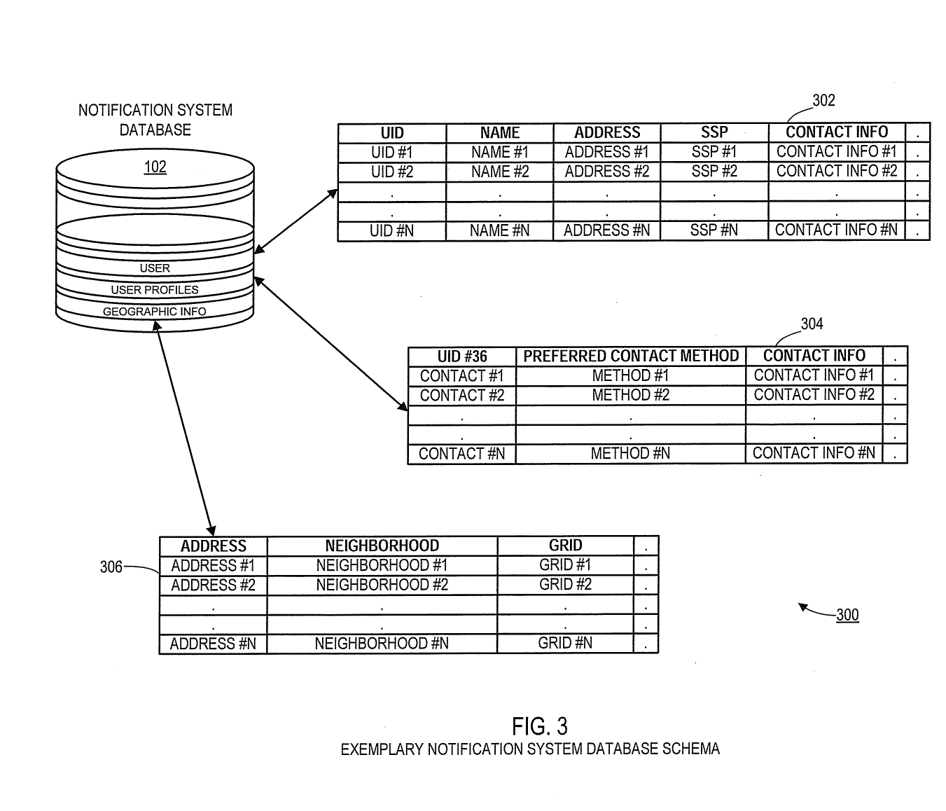

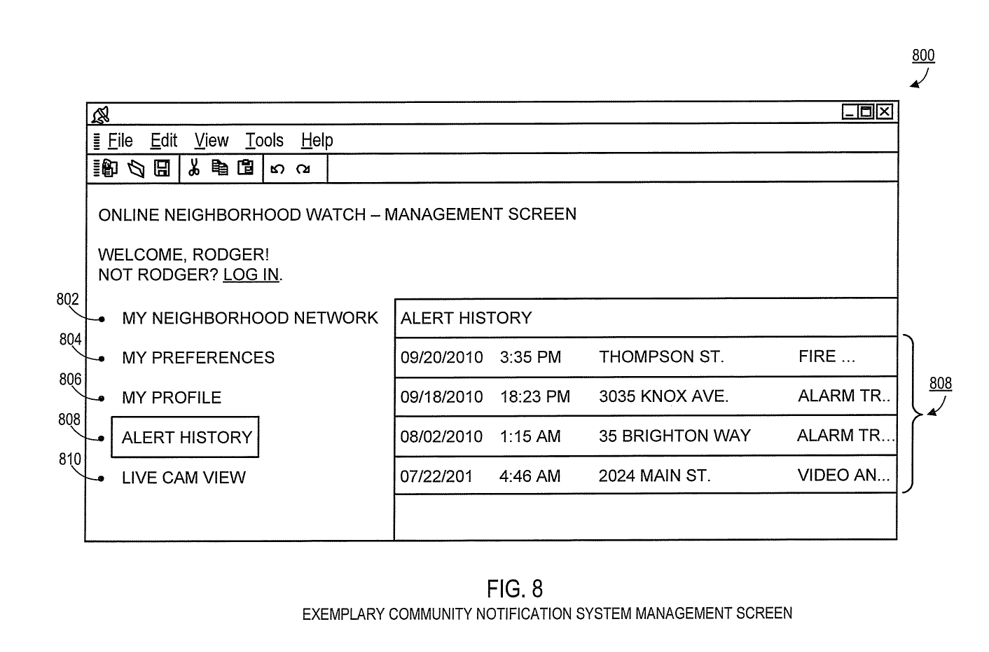

For purposes of example and explanation, it can be assumed that system user 106a registers with an embodiment of the CNS 100. The registration (usually a one-time activity) can be accomplished in a conventional manner via a website operated by the CNS system administrator, or via a user's mobile device through a mobile device application program that communicates with the CNS 100. During registration, the user 106a provides relevant information, such as the user's name, address, SSP (if applicable), contact information, one or more preferred contact methods, preferred neighborhood members, a neighborhood network type, and other similar types of information (described in greater detail below). According to aspects of the present disclosure, it will be understood that a neighborhood network type can include a single family residence, a commercial building, a condominium, a corporation's office or establishment, or any other type of property as will occur to one of ordinary skill in the art. Typically, as will be understood, information provided by system users in a registration is stored in an exemplary notification system database 102. An exemplary notification system database schema for storing data and information that is used by an embodiment of the CNS is explained subsequently in connection with FIG. 3. Further, a system user 106 is able manage his or her account with an embodiment of the CNS 100 through a user management interface, as shown exemplarily in FIG. 8.

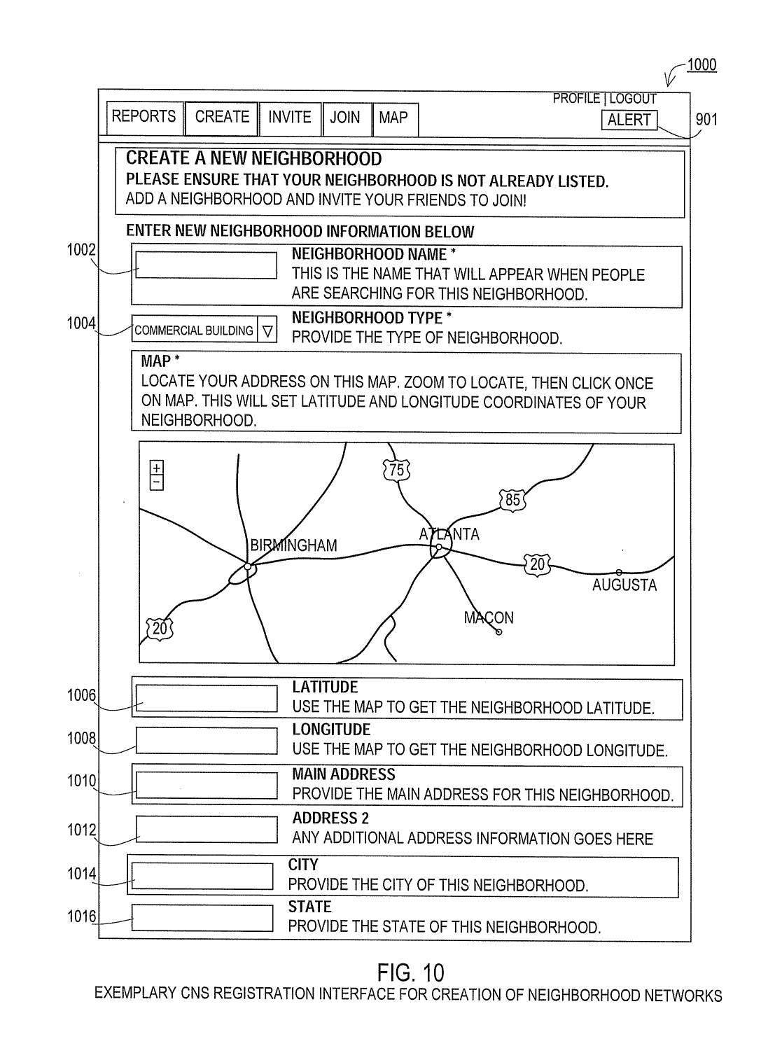

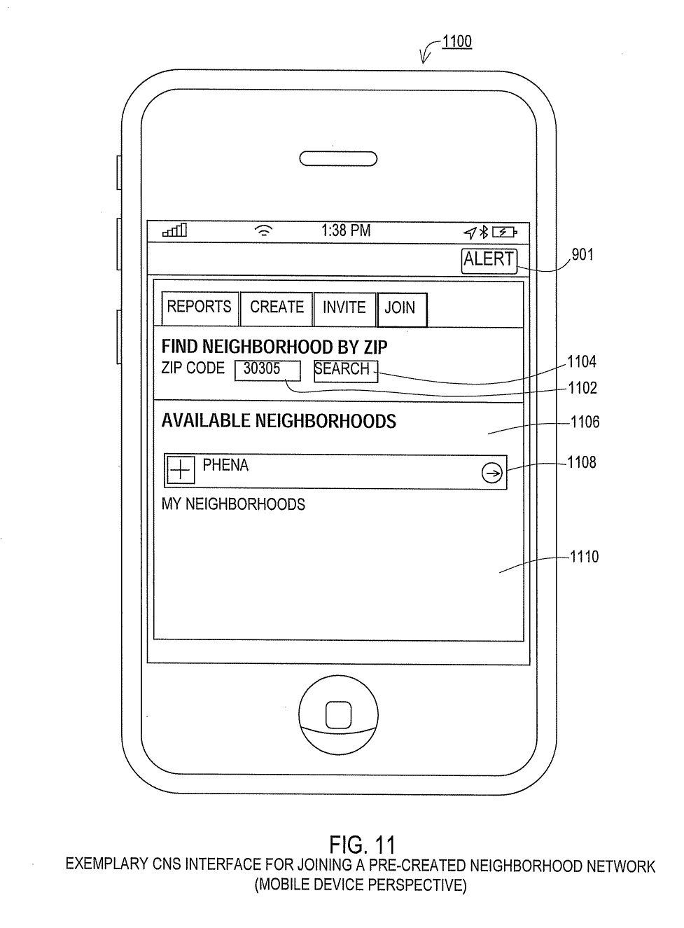

Still referring to FIG. 1, it is assumed that neighbors 108a-108n also register with the CNS, similar to the user 106a, and provide information similar to that provided by the user 106a. The CNS receives the registration information and generates one or more “neighborhood networks” 112a for relationally linking together the various users 106a and neighbors 108a-108n in the network 112a (described in greater detail below). An exemplary screenshot of a registration interface is shown in FIG. 10.

Generally, a user profile is generated for each system user that defines each user's custom “neighborhood network.” This linking and creation of a neighborhood network can be done automatically by the CNS, or manually by a user 106 or system operator, or via some combination of manual and automated generation. As referred to herein, the term “neighborhood network” or “community network” or “community” is intended to describe a relational construct that connects various system users into a predefined group based on geographic proximity of the members, or specific manual selection of particular members, or other grouping of system users based on some other relational criteria. Therefore, it will be understood that a neighborhood network is not limited to adjacently located, or co-located geographical areas, and can include persons from disparate geographical areas.

Further, as will be understood, various system users may belong to a plurality of neighborhood networks depending on the location of the user's property and/or preferences associated with the networks. For example, as shown in FIG. 1, neighbor 108n is a member of not only neighborhood network 112a, but also network 112b. As will be understood and appreciated, the users 106b and neighbors 108c-108m of network 112b register with the CNS 100 in the same manner as those users and members of network 112a.

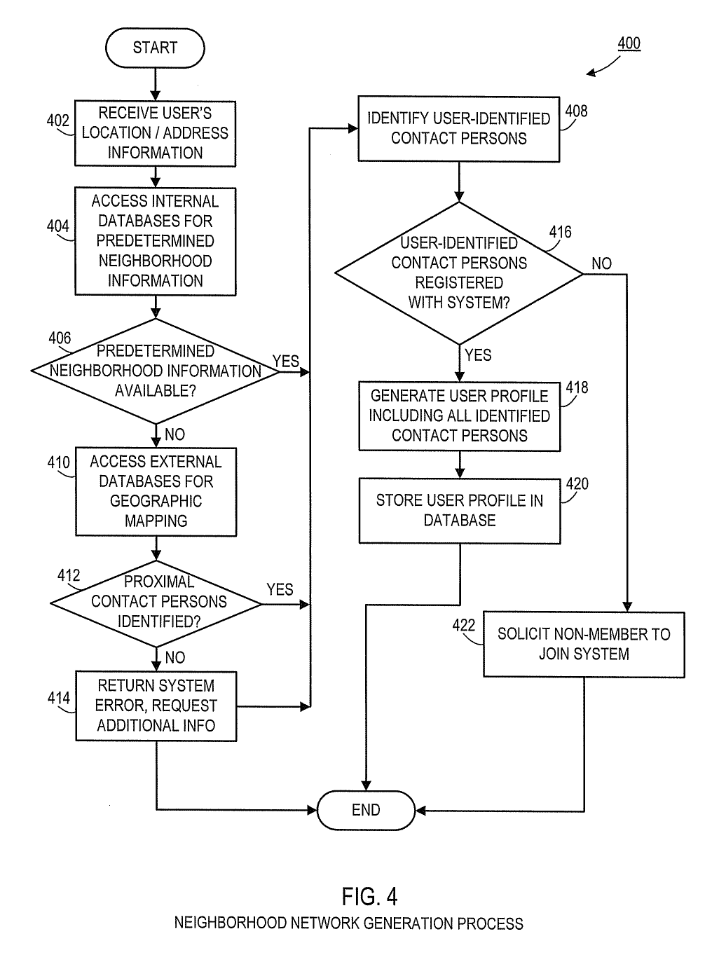

Continuing with the above example, assume that a user 106a, 106b of the system 100 experiences an emergency or event at the user's home or geographic location. As referred to herein, an “event” means any emergency, occurrence, or other situation that occurs at a geographic location that prompts a signal to be sent to the CNS 100, such as a burglary or home break-in, fire, carbon monoxide alarm, 911 distress call, or other similar event. Further, an event can also include suspicious activities at a location, lost/found property, maintenance problems, and other non-emergency events. As shown in FIG. 1, the event occurring at user 1's home is that a burglar 120 has broken into the home, whereas the event occurring at user 2's business is a fire. Upon occurrence of the event, a security system operational at each geographic location is triggered, which sends event information to the corresponding security service provider(s) (“SSPs”) 116, and the SSPs then notify local police and fire personnel of the event. According to an embodiment, however, the SSP also notifies the CNS 100, which then provides event information relating to the burglary at user 1's 106a home to neighbors 108a-108n in neighborhood network 112a, and event information corresponding to the fire at user 2's business 106b to neighbors 108c-108n in neighborhood network 112b. According to one aspect of the present disclosure, linking and creation of a neighborhood network can be done automatically by a CNS process, and is discussed exemplarily with a flowchart in connection with FIG. 4.

According to another embodiment, in the event that burglar 120 has broken into user 1's 106a home, user 1 sends an alert via an electronic computing device (such as a laptop as shown in FIG. 1, or a mobile device, or some other device) directly to the CNS. According to various other embodiments, neighbors 108 are notified of events via predefined notification formats, such as telephone, email, text or SMS messages, social media posts, etc. The neighbors can then watch the event or emergency (e.g., from their own homes they can see what is taking place at a neighbor's home), take pictures, video the event, and if they are so inclined, help or come to the aid of the affected system user 106. This overall system functionality enables potentially quicker responses to emergency situations (i.e., neighbors can assist an endangered homeowner), better record-keeping, documenting, or witnessing of emergencies (via neighbor surveillance), and provides a deterrent effect to crime.

In other system embodiments, rather than triggering a conventional alarm system, an event is identified and/or triggered by a system user 106 activating an alarm device, such as a mobile telephone operating an alarm application, or via a dedicated device in operative communications with the CNS 100. Alternately, in other embodiments, an event is identified by a system user and reported to the CNS 100 via a user's electronic computing device accessing a website operated by a CNS system administrator, or via a mobile device application program that communicates with the CNS 100. Examples of system users' electronic computing devices include but are not limited to laptops, desktops, mobile phones, “smart” phones, tablet computing devices, personal digital assistants, or any other device that is capable of accessing the world wide web. In these embodiments, the user may not require a conventional alarm system (or the conventional alarm system may be turned off or deactivated at the time of the event); instead, the event information is transmitted directly from the user's device to the CNS 100, which then notifies neighbors in the respective neighborhood network 112. Further, even if a system user 106 employs a traditional security system, aspects of the present system may be implemented such that a control unit associated with a conventional security system at a system user's home sends event information directly to the CNS prior to or concurrently with the notification to the SSPs. This avoids potential delay based on the SSPs' transfer of event information from the user's location to the CNS 100.

As described in greater detail below, the event information provided to neighbors during an emergency or other occurrence may comprise the geographic location (also referred to herein as “geo-location”) at which the event is occurring, a description of the event, the time the event occurred, potential warnings or suggestions for addressing the event, information about the occupants of the geographic location, audio or video information, whether emergency responders have responded to the event, etc. This information may be obtained via a variety of information sources, including information sensors at the user's home (e.g., audio recorders, video recorders, motion detectors, etc.), information obtained during a telephone conversation between an SSP representative and the user, pre-stored information maintained within the notification system database 102, information reported to the CNS 100 by a system user, and other similar information sources as will occur to one of ordinary skill in the art. Generally, this information is delivered via automated or pre-recorded or pre-formatted messages to neighbors 108, and information is retrieved from the geographic location and inserted into predetermined message formats for sending to affected neighbors 108.

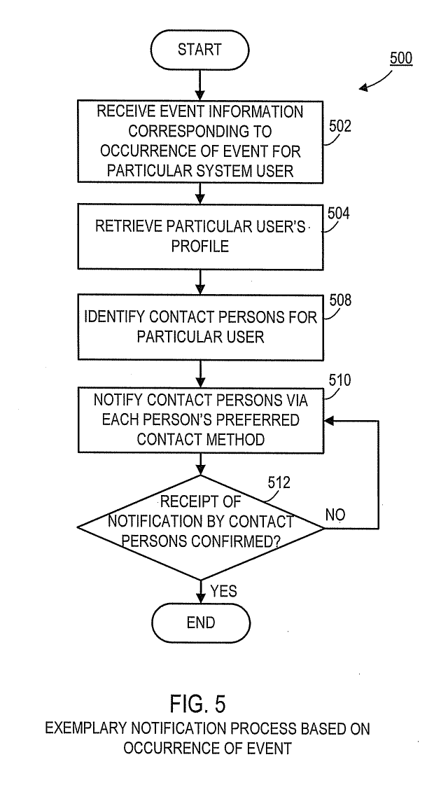

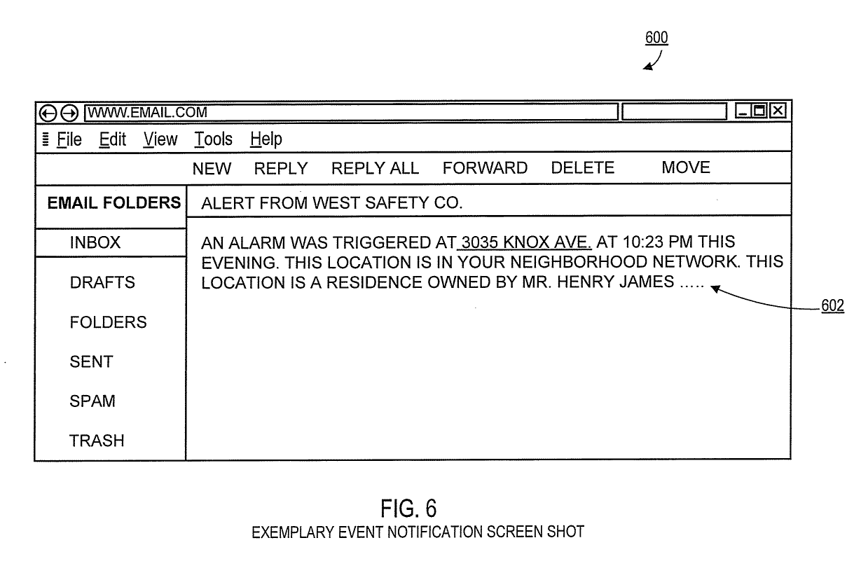

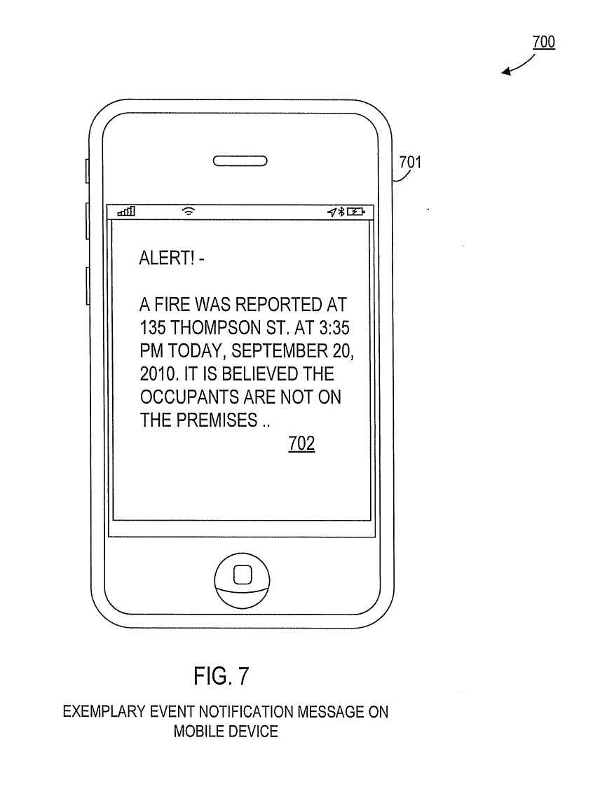

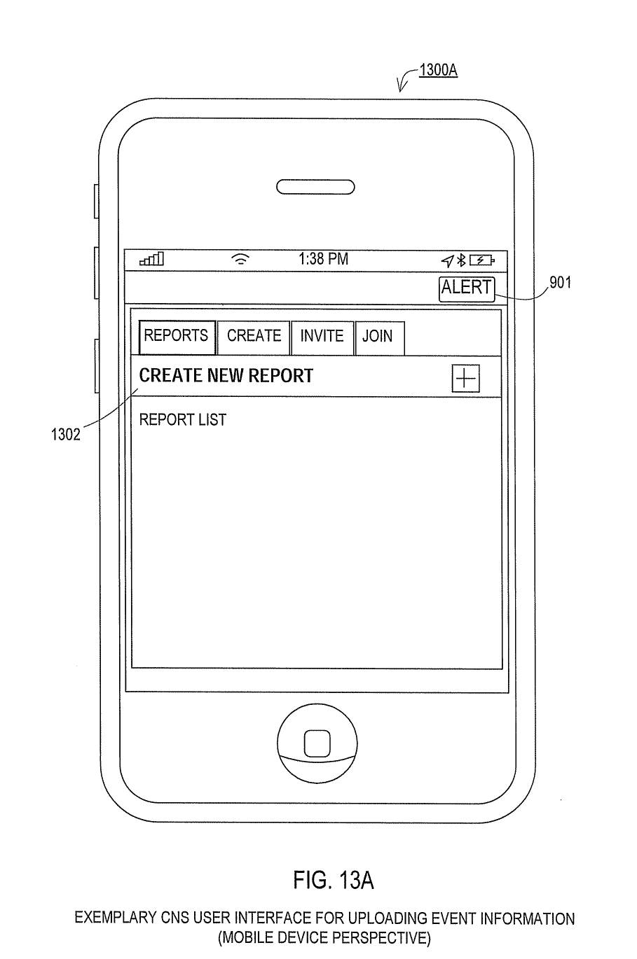

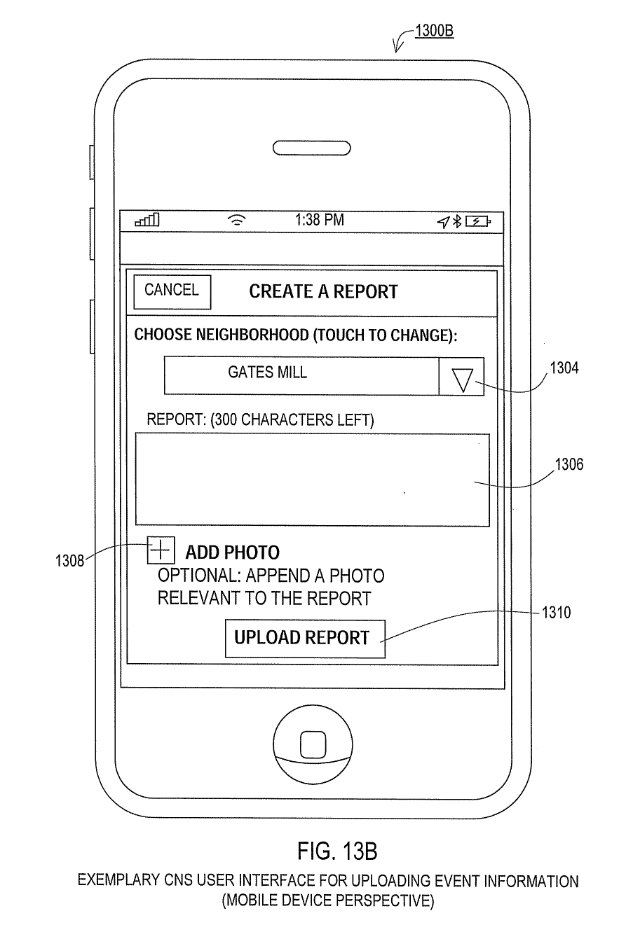

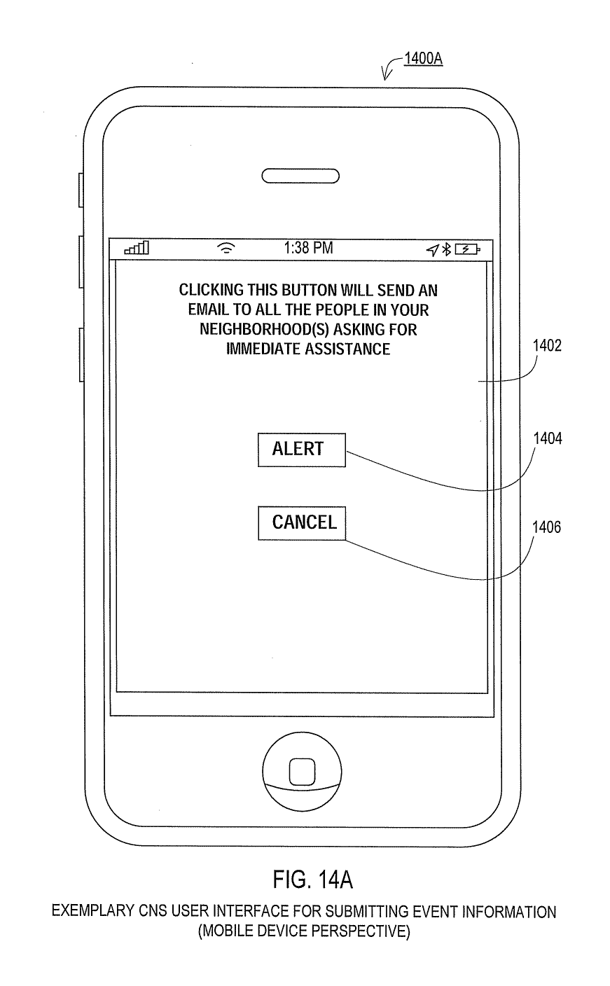

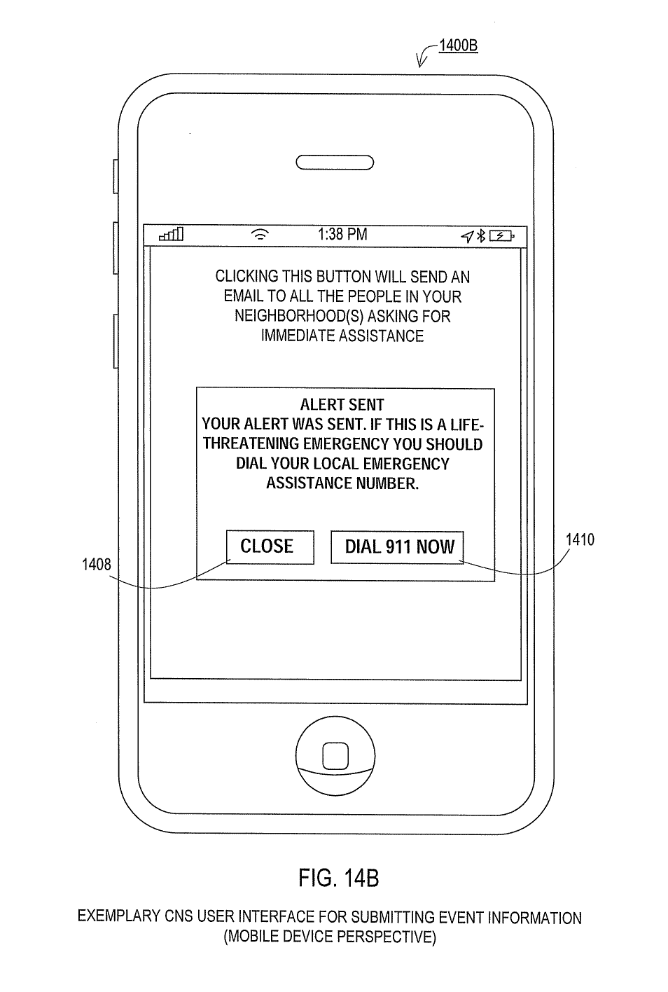

In another aspect, system users 106 can create reports (notifications) based on the occurrence of an event or emergency at the system user's geographic location. Such reports are conveyed automatically by the system user's electronic computing device to the CNS 100, and subsequently persons who are members of the same neighborhood network as the reporting user are notified of the event. Exemplary screenshots for creating, uploading, and submitting reports via a user's mobile device are shown in connection with FIGS. 13A, 13B, 14A, and 14B. As recited previously, examples of system users' electronic computing devices include (but are not limited to) laptops, desktops, mobile phones, “smart” phones, tablet computing devices, personal digital assistants, or any other device that is capable of accessing the world wide web. An exemplary notification process involving receiving relevant event-related information and further disseminating such information to respective members of respective neighborhood networks is discussed exemplarily in FIG. 5. Moreover, exemplary screenshots of event notifications as seen by members in a neighborhood network are shown in FIG. 6 and FIG. 7.

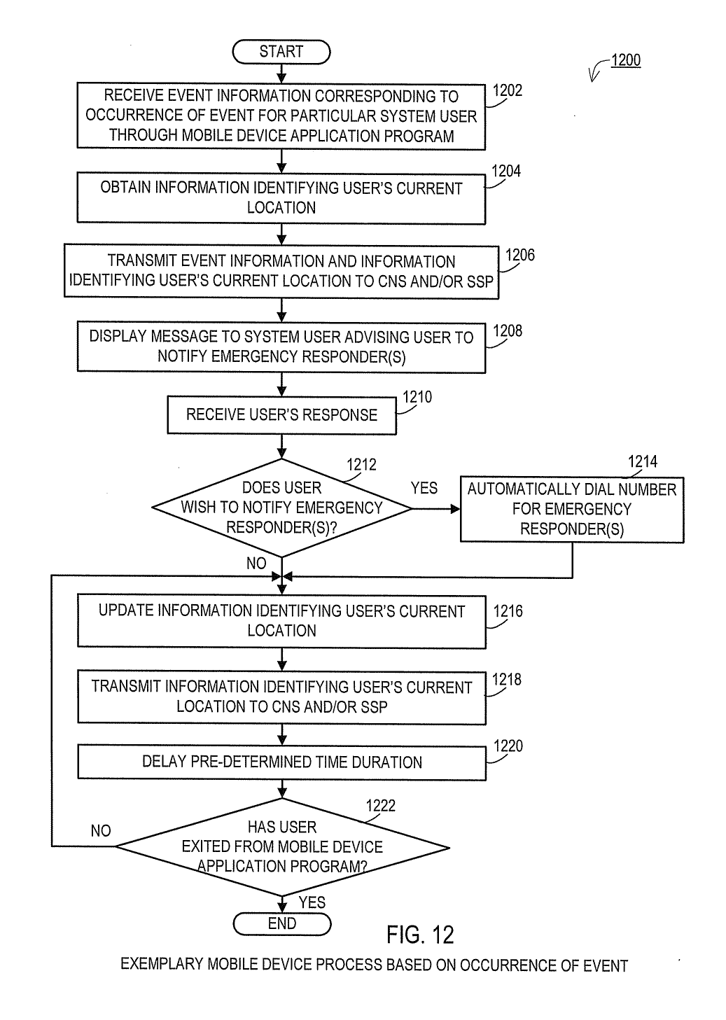

According to one aspect of the present disclosure, in connection with transmission of information relating to an event, a system user's mobile device automatically transmits to the CNS 100 additional information corresponding to the user's real-time geo-location. In many scenarios, a mobile device application program running on the system user's mobile device transmits such geo-location information, wherein usually the real-time geo-location information is obtained with the help of a location sensor embedded in the mobile device that communicates with the mobile device application program running on the user's mobile device. Alternately, a mobile device application program running on the user's mobile device communicates with a third-party location-based service provider (such as LOCAID™, of San Francisco, Calif., for example) which then provides the user's current location to the CNS 100. It will be understood that such a mobile device application program is typically provided by the CNS 100 for download and use by system users 106, 108. An exemplary mobile device process for notifying and providing relevant event information to other members in the neighborhood network of a system user, based on the occurrence of an event or emergency at the system user's geographic location, is shown in FIG. 12.

According to another aspect, the location sensor (as recited in previously) in the user's mobile device utilizes software to determine its current location by using network information, such as Internet addresses or WIFI network addresses. According to yet another aspect, the real-time location of a user's mobile device can be retrieved by using mobile cell tower information, cell tower triangulation information, or mobile network information. As will be understood and appreciated by one of ordinary skill in the art, various mechanisms can be utilized to identify a current geographic location of a user's mobile device according to various aspects of the present system, and embodiments of the present system are not limited to the specific mechanisms described herein. Further, a user's mobile device can include various other devices and systems that are already known in the art, and that will be introduced in the future. The discussion above in association with FIG. 1 merely provide an overview of an embodiment of the present system for automatically notifying and providing relevant information to registered system users, such as those within a specific geographic area or interrelated as part of a community, about an occurrence of an event (or, an emergency) at a geographical location, and are not intended to limit in any way the scope of the present disclosure. Various architectural details of an embodiment of the disclosed CNS will be described next in greater detail.

FIG. 2 illustrates an exemplary system architecture 200 of the community notification system (“CNS”) 100 according to one embodiment of the present system. According to one embodiment of the present disclosure, an embodiment of the CNS 100 is hosted on a third party physical server, or a cloud server. As shown, the system architecture 200 includes one or more notification system databases 102, one or more CNS servers 202, and a plurality of software modules or algorithms operated by the CNS server 202. In the specific embodiment shown, the software modules include an overall notification management module 204 that manages the operations of the CNS 100, and further includes sub-modules such as a registration module 206, a mapping/geographic coordination module 208, and a notification module 210. As will be understood and appreciated, the specific modules and databases in FIG. 2 are shown for illustrative purposes only, and embodiments of the present system are not limited to the specific architecture shown. The functions and operations of these exemplary modules and system components are described in greater detail below.

As shown in FIG. 2, the CNS 100 also includes operative connections to one or more third party information sources 212. These third party information sources 212 include information that is utilized by embodiments of the present system during registration of a system user, or during generation of a neighborhood network via the mapping/geographic coordination module, or during other similar system processes. For example, one embodiment of the CNS utilizes publicly-available real estate information, such as neighborhood plot information, or geospatial coordinate information, when determining a location of a system user's residence and associating a neighborhood network with the system user. As another example, the registration module may retrieve and pre-populate a system user's profile with publicly-available address and contact information during registration so as to reduce registration time. Other third party information sources are contemplated for use with embodiments of the present system as will occur to one of ordinary skill in the art.

Generally, the registration module 206 enables system users 106 to register with the CNS 100, and obtain basic information such as user name, address (i.e., geographic location or residence), security system provider, preferred mode of communication (e.g., phone, email, SMS message, social media system post, etc.), and other similar types of information and preferences. In one embodiment, the registration module generates a unique user profile for each user that enables efficient storage and retrieval of information within the notification system database 102. The registration module 206 also obtains consent, authorization, privacy, and waiver information from each system user 106 such that other users (e.g., neighbors 108) may be contacted in case of a user emergency (i.e., event), and so that the user may be contacted if his or her neighbors experience emergencies, etc. As will be understood and appreciated, information may be provided by and displayed to system users 106, 108 during registration via a conventional graphical user interface (not shown). According to one embodiment, only users that have registered with the CNS 100 are entitled or permitted to be contacted in the event of an emergency, or to have others contacted (e.g., neighbors) in the case of an emergency. In other embodiments, notifications of events may be sent to a user's neighbors 108 based on publicly-available contact information even if those neighbors have not registered with the CNS.

Still referring to FIG. 2, as mentioned above, the notification management module 204 also includes a mapping/geographic coordination module 208 and a notification module 210. Generally, the mapping/geographic coordination module provides functionality for mapping a user's geographic location to other locations in geographical proximity to the user to generate a “neighborhood network” 112. For example, the module 208 utilizes spatial coordinates, real estate records, county land plot information, official town or neighborhood records, etc., to identify a given user's 106 nearest neighbors 108, and associate those neighbors (or, specifically, information corresponding to those neighbors) with the user within the notification system database 102.

As will be understood, communities can be created in a variety of ways. For example, one embodiment of the CNS 100 generates predefined map grids (similar to city blocks), and simply allocates system users into those predefined grids. In another embodiment, the system users are allocated into predetermined neighborhood groups based on actual neighborhoods defined within a community, regardless if neighbors within those groups are necessarily the closest neighbors to the system user. In yet another embodiment, an individual neighborhood network is specifically generated for each system user based on neighbors that are nearest to the system user in geographic distance or spatial relation (e.g., based on geographic coordinates). In another aspect, users may define particular persons (during registration) that should also be contacted during an event, even though those persons may not be geographically proximal to the user (such as friends, family members or relatives). In yet a further embodiment, communities or networks are created by system administrators based on predetermined criteria, such as users in a given office building or office building complex, users associated with a certain company, entity, or organization, users affiliated with a university or school, or any other virtual or physical association between members. Other neighborhood networks or communities incorporate a combination of the above-described methods, or use other methods as will occur to one of ordinary skill in the art. An exemplary process for generating a neighborhood network is described in greater detail below in connection with FIG. 4.

Still referring to FIG. 2, the notification module 210 implements an automated process (e.g., a proprietary algorithm) to automatically notify neighbors 108 and other system users via their preferred notification means upon the occurrence of an event (e.g., emergency, break-in, fire, etc.). Upon occurrence of an event, event information is transmitted to the CNS 100 (either directly from a system user's 106 location, or from a SSP 116), where it is received and processed by the notification module 210. Typically, and in one embodiment, event-related information is transmitted by a system user's electronic computing device. An exemplary notification process involving receiving relevant event information, and further disseminating such information to respective members of respective neighborhood networks, is discussed exemplarily in FIG. 5. Further, an exemplary mobile device process for providing information to the CNS for purposes of subsequently notifying and providing relevant event information to other members in the neighborhood network of an affected system user, based on the occurrence of an event or emergency at the affected system user's geographic location, is shown in FIG. 12.

After receiving the event-related information from an affected system user, the notification module 210 then accesses the user profile within the notification system database 102 for the affected system user, retrieves the user's neighbors (i.e., contact persons), and notifies each person automatically of the event via his or her preferred communication mode. For example, emails can be auto-generated and populated with user-specific information. Or, a voice recording can be used to call neighbors, again with populated user-specific information, such as with a computer-generated voice. As will be understood and appreciated, notification of neighbors and provision of event-specific information can be carried out in a variety of ways as will occur to one of ordinary skill in the art. An exemplary process for notifying a neighborhood network of an event is described in greater detail below in connection with FIG. 5. Screenshots of exemplary notifications are shown in FIG. 6 and FIG. 7. In what follows next, various data attributes relating to dissemination of event related notifications will be described in greater detail.

FIG. 3 illustrates an exemplary notification system database schema 300 for storing data and information that is used by an embodiment of the community notification system 100. According to one embodiment, user data and information is provided by system users 106 when the users register with the CNS. An exemplary CNS interface for registering users and further creating neighborhood networks will be described in connection with FIG. 10. As shown in FIG. 3, the database 102 is a relational database that is formatted to include multiple data tables that link together to conveniently link and store various types of system data. As will be understood and appreciated, the specific tables and data items shown are provided for illustrative purposes only, and embodiments of the present system are not intended to be limited to the specific types of information shown.

As shown in FIG. 3, the database 102 includes at least a user information table 302, a user profile table 304, and a geographic information table 306. Generally, the user information table 302 stores information relating to system users 106, such as user name, a user identifier, social security number, address (or geographic location), social security provider, various types of contact information (e.g., phone number, email address, etc.), and other similar types of information. The exemplary user profile data table 304 stores user profile information for a specific user. For example, the table 304 shown in FIG. 3 relates to the user assigned with user identifier 36. This specific user includes N contact persons (e.g., neighbors), and for each contact person, that person's preferred contact method (e.g., telephone, email, SMS message, etc.) in the event of an emergency or occurrence, and the specific contact information that relates to the preferred contact method. Thus, when an event occurs for a specific user 106, that user's information may be retrieved from the user information table 302, and further from the user profile table 304 to identify the user's neighbors such that those specific neighbors may be identified according to their preferred contact methods.

Generally, the geographic information table 306 stores information that relates to each geographic location associated with each system user stored within the database 102. As shown, the table 306 includes address information, a predefined “grid” for each address, a predefined “neighborhood” for each address, etc. This geographic information is used to identify and/or define a specific neighborhood network 112 made up of other system users (neighbors) for each particular system user. Again, as will be understood and appreciated, various other types of information tables and data not specifically shown in FIG. 3 are utilized within embodiments of the present system as will occur to one of ordinary skill in the art. According to one aspect of the present disclosure, the function of linking and creation of neighborhood networks can be done automatically by the CNS, or manually by a user 106 or system operator, or via some combination of manual and automated generation. An automated CNS process relating to the generation of neighborhood networks is described next.

FIG. 4 illustrates an exemplary process 400 for generating a network of associated system users (i.e., generating a neighborhood network 112 for a given user 106) and associating those system users with each other in a database 102. The process 400 begins at step 402, wherein the mapping/geographic coordination module 208 receives information relating to a user's location or address. Generally, this information is input into the CNS 100 by a system user 106 via a user interface. In one alternate embodiment, information relating to a user's location or address is communicated from a user's electronic computing device. Such an embodiment will be discussed in greater detail in connection with FIG. 12, wherein a user's mobile device communicates information relating to a user's location or address to the CNS. As shown in FIG. 4, at step 406, the module 208 accesses the notification system database 102 to identify information associated with predefined neighborhoods within the CNS. For example, specific neighborhood networks including lists of other system users that reside in close proximity to the specific user may already be stored within the database 102. If such information is available, then the mapping/geographic coordination module 208 retains that information for subsequent processing (see step 408 and subsequent steps, described in greater detail below).

If predetermined neighborhood network information is not available for the specific user, then the process 400 moves to step 410, in which the mapping/geographic coordination module 208 accesses external databases and information sources 212 to identify system users with residences or other geographic locations in proximity to the specific system user 106. As mentioned previously, these external databases could be real estate records, county land plot information, online databases or map tools, and other similar types of information. Generally, the CNS 100 utilizes predetermined rules when retrieving information from external databases. For example, the system may search for other system users within a 0.5 mile radius of the particular system user. As will be understood, various types of rules or settings may be used to identify proximally-located system users. If no proximal contact persons (e.g., neighbors 108) are identified via external databases (e.g., the system user lives in a remote location with no close neighbors), then the process 400 moves to step 414, in which a system error is returned, and/or the system user is asked for additional information. According to one embodiment, the process 400 then moves to step 408. In another embodiment, the process ends, and the system user is denied registration to the CNS 100.

Still referring to FIG. 4, if a predetermined neighborhood network was identified (step 406), or if proximal neighbors were identified via one or more external databases (step 410), or if no proximal neighbors were identified (step 414), then the process 400 moves to step 408, in which the system queries the specific user to identify other contact persons he or she wishes to include in his or her “neighborhood network” 112 that may not necessarily be proximally related to the user (e.g., family members in other towns or cities, close friends, etc.). If such persons are identified and are previously-registered users of the CNS 100 (step 416), then the module 208 generates a user profile for the specific user that includes all contact persons (e.g., neighbors 108) identified for that user (either through predetermined neighborhoods, or external databases, or specific by the system user, or via other mechanisms contemplated by those of ordinary skill in the art) (step 418). As mentioned previously, the user profile includes information about each neighbor in the user's network, including contact information, preferred contact methods, etc. At step 420, the user profile is stored in the notification system database 102 for subsequent use, and the process 400 ends.

If, at step 416, the specifically-identified contact persons are not already registered with the CNS 100, then the CNS solicits those persons to join the system (step 422). According to various exemplary embodiments, non-users are solicited based on contact information that is publicly available, or provided by the specific system user, etc. In one embodiment, the specifically identified person(s) are not allowed to join the specific user's neighborhood network until they register with the CNS 100. After soliciting the non-members, the process 400 ends.

As will be understood, alternate embodiments of the present system allow neighborhood networks to be generated by different methodologies, e.g., neighborhood networks can be created by system users simply by providing information relating to the user's friends or family (or other specific users), or creating networks relating to predefined groups of people (e.g., employees at a company), etc. An exemplary screenshot showing an interface for creating communities will be discussed in connection with FIG. 10.

FIG. 5 illustrates an exemplary notification process 500 for notifying and providing relevant event information to neighbors 108 of a system user 106 based on the occurrence of an event or emergency at the user's geographic location. At step 502, the CNS 100 (and, according to the specific embodiment shown in FIG. 2, the notification module 210), receives event information corresponding to occurrence of an event at a particular system user's geographic location. As mentioned previously, this event information may include conventional information received by a SSP 116 during an emergency, or additional information such as audio or video information relating to the specific event at the user's location, or other similar types of information. As also mentioned previously, this information may be transmitted from an SSP 116, or directly from a user's location (e.g., via a control box, such as those used with conventional SSP security systems). Further, it will be understood that event information can also be communicated from a user's electronic computing device. In one embodiment, and as will be discussed in greater detail in FIG. 12, a user's mobile device communicates event information to the CNS. Exemplary screenshots displaying various aspects of use of a mobile device in connection with an embodiment of the present system will be discussed in connection with FIGS. 13A, 13B, 14A, and 14B.

Still referring to FIG. 5, once event information is received for an emergency or event at a user's location, at step 504, the module 210 retrieves the user profile from the notification system database 102 for the specific user affected by the event. The user's profile generally includes contact persons to be contacted in the event of an emergency, the contact persons' contact information, preferred contact methods, names, addresses, etc. (step 508). At step 510, once the contact persons of the user are identified, those persons are notified of the event via each person's preferred contact method or methods (multiple methods may be used for each person, if desired). According to one embodiment, notification occurs by inserting, at the CNS 100, event information into predefined message strings or formats, such as predefined SMS messages, emails, voice messages, and the like. For example, a predefined email may include a template that states that an emergency is occurring at a residence, but requires event information to be input relating to the type of emergency, the specific location of the emergency, the time of the emergency, the owner(s) of the location at which the emergency occurred, whether emergency responders 114 have been dispatched, and various other types of information. This event information is extracted and input into the message templates and sent to other system users according to methods understood by those of ordinary skill in the art.

At step 512, according to one embodiment, the system 100 verifies that the affected neighbors 108 have received their notification messages via a confirmation mechanism (e.g., email message that requires the recipient click a “received” window prior to being able to read the message). If receipt of the message is confirmed, then process 500 ends. If receipt is not confirmed, then steps 510 and 512 are looped until all recipients have confirmed receipt of the message, and/or some other process-ending event occurs. In what follows next, various screenshots that show exemplary notifications received by members of a neighborhood network, based on the occurrence of an event or emergency at the system user's geographic location, will be described.

FIG. 6 shows an exemplary screen shot 600 of a contact person's or neighbor's email inbox with an alert/notification message 602 received from an embodiment of the CNS 100. As shown, the message indicates that a burglar alarm was trigged at a specific address (i.e., the address of a user 106 in the given neighbor's neighborhood network 112) at a specific time. The specifically-shown message 602 also indicates the owner of the residence at issue (e.g., in case the neighbor is unaware of his or her neighbors' addresses, but knows the owners of the properties). As described previously and as will be understood and appreciated, virtually any type of information can be included in the message 602 that may be helpful to a neighbor 108 in the event of an emergency, as long as that information can be collected by the CNS 100. In many scenarios, more than one user can report an event or emergency to the CNS. For example, if a break-in occurs at a residence, then neighbors who reside in adjacent houses can report the break-in to the CNS. Accordingly, in one embodiment, members who are in the same neighborhood network will receive several notifications corresponding to reports sent by neighbors relating to the break-in.

FIG. 7 shows an exemplary screen shot 700 of a contact person's or neighbor's mobile device 701 with an alert/notification message 702 received from an embodiment of the CNS 100 and displayed on the mobile device via a SMS message or Internet email display. This screen shot 700 illustrates the variety of contact methods that may be used to notify neighbors 108 of events occurring at their other neighbors' properties.

As mentioned previously, in one embodiment, in addition to or in lieu of an operative connection with SSPs 116, users of the CNS 100 are able to wear a communication device (such as a necklace or bracelet), or operate a handheld device, or have an application or software installed on their mobile device 701 that enables the users to make a call to the CNS 100 in the event of an emergency or event. If such a call or “panic” button-type trigger occurs, the CNS 100 notifies community members or neighbors of the user of the emergency in the manner described above. In this way, there need not necessarily be a tie to a specific SSP, as the user can initiate the CNS functionality from a device. Or, the device 701 may be used when an SSP security alarm is turned off at the user's residence, or if the security alarm fails to trigger in the event of an emergency, etc. As recited previously, according to an aspect, system users are able to access the CNS via the Internet and manage their user accounts, manage their histories of alerts, configure various preferences of receiving notifications, and perform other tasks with the help of a simple, user-friendly interface.

FIG. 8 illustrates an exemplary management screen 800 that enables a system user 106 to manage his or her account with an embodiment of the CNS 100. As will be understood, this screen 800 can be accessed via the Internet 110 or some other network. As shown, the management screen includes links and/or folders to the user's neighborhood network 802 (e.g., a display of the neighbors 108 in the user's network and their respective information), the user's preferences 804 (e.g., preferred contact methods, etc.), the user's profile 806 (e.g., address, SSP, etc.), alert history 808 (e.g., a listing of past notifications or alerts provided to the user based on events that occurred in his or her neighborhood network), a live camera view 810 (e.g., live view of the user's residence or physical location, or of other neighbors' residences in the neighborhood network), and other similar links not specifically shown. In the specific example screen 800 shown in FIG. 8, the user's alert history 808 listing is shown, which provides information relating to past events that have occurred at the user's residence or at residences in the user's network. As will be understood and appreciated, a variety of other types of information and functionality are able to be viewed and accessed via other embodiments of the management screen 800. For example, according to one embodiment, the CNS (via the management screen 800) allows users to view a geo-location corresponding to the occurrence of an event or emergency. Such a CNS functionality will be described in greater detail next.

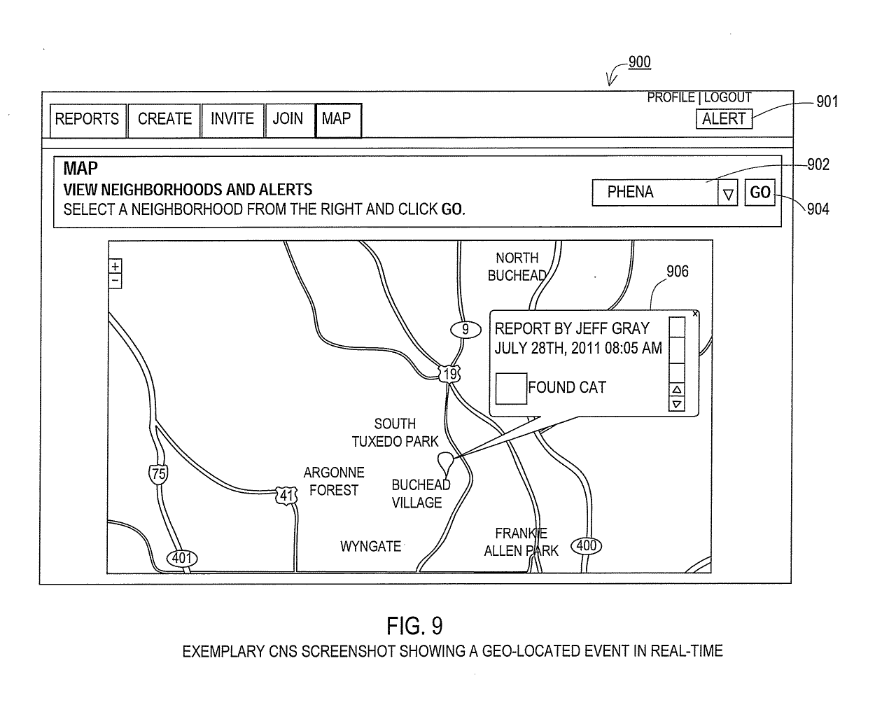

FIG. 9 illustrates an exemplary screenshot 900 of a CNS interface showing a geo-location corresponding to the occurrence of an event or emergency. As shown in region 906, an event (corresponding to a lost cat) was reported by a system user called Jeff Gray, on Jul. 28^{th}, 2011 at 8:05 AM. It will be understood that system users who view this report can further disseminate this report (and notify other users in the same neighborhood network) by clicking on an alert button 901. In the screenshot 900, an exemplary neighborhood network called “Phena” is shown. In other words, it will be understood that users viewing this interface (and also likely user Jeff Gray) are members of the Phena network. It will occur to one of ordinary skill that a system user can be a member of more than one neighborhood network or community. Thus, a dropdown menu 904 allows a system user to select various neighborhood networks and view geo-located events therein. After selecting a neighborhood network, users click on a “Go” button 904 to submit the selection to the CNS, which, in turn, shows reports of events occurring in the selected neighborhood network. It will be understood that system users may report various other events, suspicious activities, emergencies, and the like. According to one aspect, a system user (such as Jeff Gray) reports events using electronic computing devices such as laptops, desktops, mobile phones, smart phones, etc. In one such exemplary aspect, a real-time geo-location corresponding to an event or emergency is usually obtained with the help of a location sensor embedded in a user's mobile device, and is automatically communicated (at pre-determined periodic intervals of time) over an electronic network to the CNS. Correspondingly, the CNS receives the information relating to the event and additionally, relating to the corresponding geo-location, from a system user, and broadcasts such information in real-time to members of the neighborhood network who are in the same neighborhood network as the system user. A flowchart illustrating an exemplary mobile device process will be described in connection with FIG. 12.

In another exemplary aspect, a system user manually provides a geo-location (in the form of a latitude/longitude, a physical address, or any other location identifier) to the CNS by pointing to the geo-location on an interactive map, or typing in the geo-location through an interface. Accordingly, the CNS also broadcasts the information to members of the neighborhood network who are in the same neighborhood network as the system user. In what follows next, an interface for creation of neighborhood networks will now be described.

FIG. 10 illustrates an exemplary screenshot 1000 of a registration interface (as seen by system users, or CNS operators, and accessible via the world wide web) for purposes of creation of neighborhood networks or communities. Typically, as will be understood, information provided by system users via this interface is stored in an exemplary notification system database 102. As recited previously, a “neighborhood network” or “community” generally refers to a relational construct that connects various system users into a predefined group based on geographic proximity of the members, or specific manual selection of particular members, or other grouping of system users based on some other relational criteria. Therefore, it will be understood that a neighborhood network is not limited to adjacently located, or co-located geographical areas, and can include persons from disparate geographical areas. Such a neighborhood network can be generated automatically by the CNS, or manually by a system user or a CNS operator. A flowchart illustrating an automatic neighborhood generation process was described earlier in connection with FIG. 4.

As shown in FIG. 10, a neighborhood network name is entered through a “Neighborhood Name” box 1002 on the interface. It will be recalled from the previous discussions that neighborhood networks can comprise various types of networks. Example of types of neighborhood networks may include (but are not limited to) residential networks, commercial networks, office buildings, virtual organizations, networks relating to single family residences, condominium complexes, or any other type of property or group as will occur to one of ordinary skill in the art. Thus, in FIG. 10, a drop-down “Neighborhood Type” drop-down menu allows selection of a pre-determined neighborhood network type.

According to one aspect, neighborhood networks are uniquely identified by or associated with a location identifier or region such as latitude/longitude, street address, geographic district, etc. In one exemplary aspect, a system user points to a location on an interactive map, and in turn, the CNS extracts (from the map, and or/an accompanying database) location identifiers corresponding to that location. In another exemplary aspect, a system user manually enters a location identifier using a combination of a “Latitude” box 1006, a “Longitude” box 1008, a “Main Address” box 1010, and an optional “Address 2” box 1012. Further, the state and the city wherein the neighborhood is located is entered via a “City” box 1014 and a “State” box 1016. It will be understood that alternate embodiments of the present system can extract location identifiers by various other mechanisms, as will occur to one skilled in the art. For example, a registration interface can be available on a mobile device application program running on a user's mobile device.

Now referring to FIG. 11, an exemplary screenshot 1100 is shown of a mobile device user interface, the interface being used by system users 106 for purposes of joining a pre-created neighborhood network or community. Although in the exemplary screenshot 1100 a mobile device user interface has been illustrated, in alternate embodiments of the present system, users are able to join a pre-created network by accessing the CNS via any electronic computing device (including laptops, desktops, etc.), capable of accessing the world wide web.

In one embodiment, a user can search for pre-created neighborhoods in a geographical area by zip code, address, city, state, geographic coordinates, neighborhood designation, entity name, or other similar identification criteria. Thus, for example, as shown in FIG. 11, a “Zip Code” box 1102 is provided for users to enter a zip code corresponding to a geographical area of interest to the system user. Then, after entering the zip code in box 1102, the user clicks on “Search” button 1104 to submit the search query to the CNS 100. Accordingly, the mobile device program running on the user's mobile device communicates the user's search query via one or more communication networks to the CNS. In turn, the CNS receives the search query, and responds back with one or more networks corresponding to the user's zip code. The outcome of the response is displayed exemplarily in an “Available Neighborhoods” region 1106 of the mobile device interface. For example, it is shown in FIG. 11, when a user enters a zip code 30305, the CNS responds back indicating that a neighborhood network named Phena is located in the geographical region corresponding to zip code 30305.

It is also shown in FIG. 11 that a user can obtain additional information corresponding to the available network neighborhood by clicking next to the name of the displayed neighborhood network. For example, as displayed in FIG. 11, a drop down region 1108 provides additional information relating to the Phena neighborhood, such as the number of users associated with the neighborhood, the neighborhood's geographic details, and other similar types of information. In another exemplarily aspect, a system user can store a list of neighborhoods which is then displayed in a “My Neighborhoods” region 1110 of the mobile device interface. As will be understood by one of ordinary skill, embodiments of the present disclosure are not limited to the display types and formats, as shown in FIG. 11. Other embodiments of the present disclosure can display similar or even, different information, and in varying display types and formats.

As recited in various sections in this disclosure, a system user 106 can use an electronic computing device capable of accessing the world wide web to communicate with the CNS. Further, it will be understood that in many scenarios a mobile device provides ease of usability to system users, and also provides a geo-location corresponding to the location of an event. In one exemplary scenario, assume a burglar breaks into the house of a system user, and further assume that the affected system user is able to lock himself or herself in a room or a bathroom. At such instances, an affected system user is able to use a mobile device to communicate an event alert to the CNS regarding the break-in. In another example, a system user (who lives in a residential neighborhood) might notice suspicious activity while driving past a neighbor's house. Accordingly, the system user can send an event alert (relating to the suspicious activity) to the CNS, with the help of a handheld, electronic mobile device. In both the above exemplary scenarios, other system users who are in turn notified by the CNS and who are in the same neighborhood network as the alerting system user are able to view, in real-time, a geo-location corresponding to the location of the event alert. Moreover, in many instances, the system users sending the alerts can be in-motion, i.e., their locations are not stationary. In those instances, users who are notified will be able to see (on the interface of a user's electronic computing device) real-time locations of the mobile system users. Details of a mobile device process, as performed by a mobile device application program running on an user's mobile device, will be described next.

Turning to FIG. 12, an exemplary mobile device process 1200 is shown for providing and disseminating relevant event information to other members in the neighborhood network of a system user, based on the occurrence of an event or emergency as identified by the system user. Generally, a mobile device application program running on a user's mobile device will be used to implement a mobile device process in association with various software/hardware modules and engines. The process usually starts when a user launches the application program, or sometimes even when a user turns on the user's mobile device. For purposes of explanation of the process 1200, it will be assumed that the system user who is using the mobile device is already a member of one or more neighborhood networks previously created within the CNS.

Starting at step 1202, the user's mobile device receives event related information corresponding to the occurrence of an event for a particular system user. Such information can be manually typed in through a mobile device interface by the user, or the user can also capture a photo, video, etc. of the event, and link/upload to the mobile device application program. At step 1204, the mobile device obtains information identifying a user's current location. Usually, a location sensor embedded in the user's mobile device provides such information to the process 1200. In alternate instances, a third party location service provider can also provide such information. At step 1206, the mobile device transmits event related information and location information to the CNS via a mobile data communication network such as a cellular network, WiFi, WiMax, computer network, etc. In alternate embodiments, the mobile device application process also transmits event information and location information to the SSP 116. Exemplary screenshots for users to upload and submit event related information via a mobile device interface are shown in FIGS. 13A, and 13B.

After a user has submitted event information, the mobile device displays (at step 1208) a message to the user 106 indicating that the user should notify emergency responders if the user feels that this is an emergency event such as an accident, a break-in, an injury etc. It will be understood and appreciated that in the present embodiment, an automated notification is not sent directly to SSPs 116. Accordingly, the user responds via an interface whether or not emergency responders should be notified, and the response is received at step 1210. Based on the user's response, the process 1200 determines (at step 1212) whether or not to notify emergency responders. If the process determines at step 1212 that the user has indicated that emergency responders need not be notified, then the process jumps to step 1216. Otherwise, the process automatically dials the number (for example, 911) for emergency responders at step 1214, and subsequently moves to the following step 1216. Exemplary screenshots of a mobile device showing the functionality of automatically dialing emergency responders, is shown in FIGS. 14 A and 14B.

As will be understood from the previous discussions, in many scenarios, the user might not be stationary. Hence, information relating to the user's current location might need to be continually updated as the even occurs. Therefore, at step 1216, the mobile device updates information identifying the user's current location, and then transmits (at step 1218) such information to the CNS 100 and/or the SSP 116. Subsequently, in one embodiment, the process 1200 delays (waits) for a predetermined duration of time, e.g., a few seconds, or a few milliseconds, etc., before moving to next step 1222. At step 1222, the process determines whether or not the user has ceased entering event related information. In one embodiment, a user ceases entering event information by exiting the system. In another embodiment, the user ceases entering event related information by clicking on a button, or typing in some characters through the interface. Various other embodiments can provide different ways of ceasing the entry of event-related information, as will occur to one of ordinary skill in the art.

If the process determines that the user has ceased entering event-related information, then the process exits thereafter. If the process determines that the user has not ceased entering event-related information, then the process loops back to step 1216 and repeats the steps thereafter.

FIG. 13 (consisting of FIG. 13A and FIG. 13B) illustrates exemplary screenshots 1300A and 1300B of a mobile device user interface for purposes of uploading to the CNS information relating to the occurrence of an event or emergency. As recited previously, according to aspects of the present disclosure, users provide reports containing information relating to the occurrence of an event or emergency, often corresponding to a user's geographical location. Such a functionality is provided with the help of a web interface or a mobile device application program interface.

As shown in screenshot 1300A, region 1302 provides users the options of creating new reports, or reviewing previously created reports. Generally, a “report” relates to an event or occurrence. When a user clicks on “Create A New Report” button, in the next screen, an interface corresponding to screenshot 1300B is displayed. Through the interface 1300B, a user can select a neighborhood corresponding to the geo-location of occurrence of the event, and further enter the description of the event. Thus, a drop-down “Choose Neighborhood” menu 1304 allows users to select a neighborhood corresponding to the geo-location of occurrence of the event, and further the description of a report is entered by users in a “Report” region 1306. In an embodiment, a user can optionally add a photo relating to an event, via “Add Photo” button 1308. Finally, the user uploads the report to the CNS by clicking on “Upload Report” button 1310. After a user clicks on “Upload Report” button 1310, screens corresponding to exemplary screenshots 1400A and 1400B are displayed.

FIG. 14 (consisting of FIG. 14A and FIG. 14B) illustrates exemplary screenshots 1400A and 1400B of a mobile device user interface for purposes of submitting to the CNS information that has been previously uploaded in FIG. 13B, in addition to calling emergency responders. As shown in FIG. 14A, region 1402 displays a message to the user indicating that a notification (for example, in an email) consisting of the report typed by the user previously (for example, as shown in FIG. 13B) will be sent to other members in the user's neighborhood network after the user clicks “Alert” button 1404. Alternately, a user can choose to cancel sending the notification by clicking on “Cancel” button 1406.

If the user clicks on “Alert” button 1404, an interface corresponding to screenshot 1400B is displayed. As shown in this screenshot, a message is displayed to the user confirming that the user's report was submitted to the CNS (in other words, members in the user's community have been notified). Further, in one embodiment, along with the user's report, the user's current location is also transmitted to the CNS by the user's mobile device. Usually, a current location of the user's mobile device is obtained with the help of a location sensor, or alternately, a location service provider. Moreover, the mobile device continues to periodically (update and) transmit a current location of a user's mobile device to the CNS, until such time that the user exits the mobile device application program and/or ceases transmission to the CNS.

In an embodiment, a user can additionally choose to inform emergency responders in case of an emergency. Thus, an exemplary “Dial 911 now” button 1410 is provided on the interface to allow users to notify emergency responders. If a user clicks on the “Dial 911 now” button 1410, the user's mobile device automatically dials the number of the emergency responder. Alternately, a user can choose not to contact emergency responders by clicking on a “Close” button 1408. It will be recalled that details of a mobile device process, as performed by a user's mobile device was described earlier in connection with FIG. 12. Although the screenshots in connection with FIGS. 13A, 13B, 14A, and 14B display user interfaces of a mobile device, it will be understood that such interfaces are meant for purposes of illustration and discussion only. Alternate embodiments of the present system allow users to interact with the CNS and view interfaces corresponding to other computing devices that are capable of accessing the world wide web, such as desktops, laptops, etc.

As described in detail above, aspects of the present disclosure generally relate to systems and methods for providing automated notifications to system users of an emergency, event, or occurrence at a given location, and wherein such system users belong to a network within a specific geographic area or interrelated as part of a community. As described herein, such a system has been referred to as a Community Notification System (CNS) that is accessible by system users via any electronic computing device capable of accessing the world wide web. Further, in one embodiment, such an electronic computing device communicates information relating to a user's current location automatically to the CNS. Accordingly, it will be understood from the foregoing description that systems and methods disclosed herein may be implemented in digital electronic circuitry, in computer hardware, firmware, software, or in combinations of them. Apparatus of the claimed invention can be implemented in a computer program product tangibly embodied in a machine-readable storage device for execution by a programmable processor. Method steps according to the claimed invention can be performed by a programmable processor executing a program of instructions to perform functions of the claimed invention by operating based on input data, and by generating output data. The claimed invention may be implemented in one or several computer programs that are executable in a programmable system, which includes at least one programmable processor coupled to receive data from, and transmit data to, a storage system, at least one input device, and at least one output device, respectively. Computer programs may be implemented in a high-level or object-oriented programming language, and/or in assembly or machine code. The language or code can be a compiled or interpreted language or code. Processors may include general and special purpose microprocessors. A processor receives instructions and data from memories. Storage devices suitable for tangibly embodying computer program instructions and data include forms of non-volatile memory, including by way of example, semiconductor memory devices, such as EPROM, EEPROM, and flash memory devices; magnetic disks such as internal hard disks and removable disks; magneto-optical disks; and Compact Disk. Any of the foregoing can be supplemented by or incorporated in ASICs (application-specific integrated circuits).

The foregoing description of the exemplary embodiments has been presented only for the purposes of illustration and description and is not intended to be exhaustive or to limit the inventions to the precise forms disclosed. Many modifications and variations are possible in light of the above teaching.

The embodiments were chosen and described in order to explain the principles of the inventions and their practical application so as to enable others skilled in the art to utilize the inventions and various embodiments and with various modifications as are suited to the particular use contemplated. Alternative embodiments will become apparent to those skilled in the art to which the present inventions pertain without departing from their spirit and scope.

What is claimed is:

1. A method for notifying and providing relevant information to members of one or more community networks relating to events happening at geographic locations, wherein the members of the one or more community networks are registered with a community notification system (CNS) that enables processing and transmission of relevant event information to and from the members of the one or more community networks, comprising the steps of:
receiving event information at the CNS indicating the occurrence of an event associated with a system user at a geographic location;
retrieving a pre-created user profile at the CNS corresponding to the system user, wherein the pre-created user profile includes information corresponding to one or more community networks associated with the system user;
identifying via the CNS one or more community members in the one or more community networks associated with the system user;
generating an alert via the CNS based on the received event information to be sent to the one or more identified community members relating to the event at the geographic location; and
transmitting the alert to the one or more identified community members to notify the one or more identified community members of the event at the geographic location.

2. The method of claim 1, wherein the event information is transmitted to the CNS by a mobile device application operating on a mobile electronic device of the system user.

3. The method of claim 1, wherein the event information is transmitted to the CNS by a security system provider in response to an alarm trigger associated with the system user.

4. The method of claim 1, wherein the event information includes location information indentifying the geographic location.

5. The method of claim 1, further comprising the steps of:
retrieving real-time location information relating to the geographic location of the event associated with the system user; and
including the retrieved real-time location information in the alert that is transmitted to the one or more identified community members,
whereby the one or more identified community members are able to identify the geographic location associated with the event.

6. The method of claim 5, wherein the real-time location information is retrieved from one or more of the following: a location sensor embedded in a mobile electronic device of the system user, a third party location service provider, a cellular network carrier, a satellite triangulation system.

7. The method of claim 1, wherein the one or more community networks are created by the members of the CNS based on personal network-creation criteria.

8. The method of claim 1, wherein the one or more community networks are created based on automated retrieval by the CNS of information maintained in one or more public databases.

9. The method of claim 8, wherein the information maintained in the one or more public databases comprises one of more of the following: demographic information, real estate information, land plot information, predefined neighborhood information, predefined organization information.

10. The method of claim 1, further comprising the steps of:
retrieving one or more pre-created user profiles corresponding to the one or more identified community members;
extracting contact information from the one or more pre-created user profiles for the one or more identified community members; and
transmitting the alert to the one or more identified community members based on the extracted contact information.

11. The method of 10, further comprising the steps of:
extracting at least one preferred contact method from the one or more pre-created user profiles for each of the one or more identified community members; and
transmitting the alert to the one or more identified community members based on each member's at least one preferred contact method.

12. The method of claim 1, wherein the step of generating the alert via the CNS comprises inserting and formatting the received event information into one or more predefined message templates.

13. The method of claim 1, further comprising the step of receiving confirmation information at the CNS from the one or more identified community members indicating that the alert was received by the one or more identified community members.

14. The method of claim 13, further comprising the step of if confirmation information is not received at the CNS for a particular community member, retransmitting the alert to the particular community member via an alternate contact method.

15. The method of claim 1, wherein the alert includes information selected from the group comprising: event type, time of event, location of event, description of event, community network members involved in the event, alert type, map information, emergency responder information.
